(19) United States
(12) Patent Application Publication
(10) Pub. No.: US 2005/0025049 A1
(43) Pub. Date: Feb. 3, 2005

(54) Communication network with traffic management by configurable active measurements

(75) Inventors: Olivier Martinot, Draveil (FR); Stephane Betge-Brezetz, Paris (FR); Michael Chevanne, Clamart (FR); Gerard Delegue, Cachan (FR); Emmanuel Marilly, Saint-Michel-Sur-Orge (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/901,072

(22) Filed: Jul. 29, 2004

(30) Foreign Application Priority Data
Aug. 1, 2003 (FR) 03 09 508

(51) Int. Cl. H04L 1/00

(52) U.S. Cl. 370/229; 370/254

(57) ABSTRACT

A communication network (N) includes switching equipment (RPi, RC) coupled together so as to allow the establishment of traffic between communication terminals (Tj). At least some of this switching equipment (RPi) includes i) application means (MA) responsible for injecting, into the network (N), additional traffic corresponding to received first values representing at least one chosen traffic characteristic, and ii) measurement means (MM) charged to carry out first passive measurements on at least one chosen traffic element, so as to deliver the first values, and then second active measurements on the additional traffic, so as to deliver second values which are representative of each chosen traffic characteristic. It also includes management means (MG) responsible for transmitting the first values to the application means (MA) and for determining from the second values whether the additional traffic verifies at least one chosen condition.

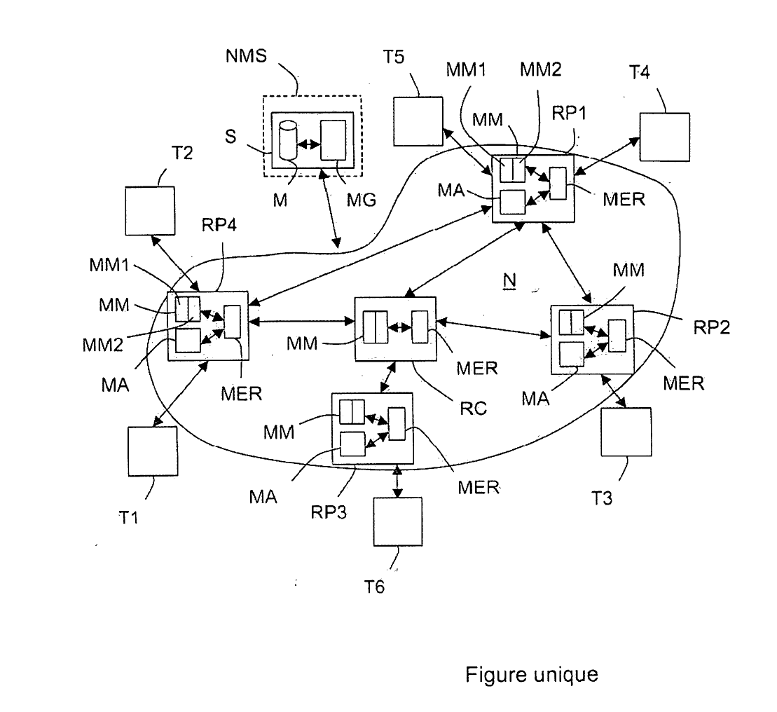

The invention concerns the field of communication networks, and more particularly traffic management within such networks.

The operators of these communication networks, said to be “managed networks”, normally conclude service level agreements (SLAs) with their customers, through which they undertake guarantee them a quality of service (QoS) which is defined by the values of traffic parameters or characteristics, such as instability (jitter), the loss of packets and transmission delays.

Two techniques are currently used to monitor the quality of service. A first technique consists of performing so-called “passive” measurements, of the local or “end-to-end” type, on the traffic to be monitored. Since these passive measurements are performed using measurement devices connected to the switching equipment (routers), they impede the operation of these routers, they cannot be automated, and they require manual configuration of their filters. As a consequence, these devices are generally limited to certain applications such as traffic engineering and factoring.

A second technique consists of performing so-called “active” measurements on additional traffic (or data flow) injected into the network and presenting similarities with the traffic that is required to be monitored. Here, the phrase “active measurements” refers to measurements effected on parameters of the additional traffic, where the partial and/or local results can be incorporated into the additional traffic where appropriate. These active measurements can provide results which are comparable to the results of passive measurements. Since this additional traffic is only partially identical to the traffic to be monitored, and only partially adaptable, it is not certain that it provides traffic characteristics (and therefore traffic content and/or profiles) that are really representative of those of the traffic to be monitored.

Moreover, neither of these two techniques enables us to determine quality of service margins (QoS) in relation to the nominal quality of service. In addition, these two techniques are implemented using measurement devices which have to be connected to the routers, and which, as a consequence, are difficult to install and to maintain in working order.

In the case of the second technique, it is known in the state of the art that this additional traffic should be performed in such a manner that it follows the same paths as the normal traffic, and that it should be classified in the same way by any quality of service management method (QoS) in the network (such as DiffServ, for example). As an example, this concern is described in the documents of Rich Whitner, Graham Pollock and Casey Cook entitled “On Active Measurements in QoS-enabled IP Networks”, published in “Proceedings of Passive and Active Measurements Workshop 2002 at Agilent Technologies”. However, the described solution cannot be used to adapt to the normal traffic in an automatic manner, and thereby to adapt to the evolution of this over time. Above all, however, it does not show how this additional traffic can be used to obtain measurements that are representative of the actual behaviour of the network.

The purpose of the invention is therefore to remedy all or part of the above-mentioned drawbacks.

To this end, a traffic management method is proposed for a communication network, consisting of performing the first passive measurements on at least traffic which has been chosen so as to deliver first values which are representative of at least one chosen traffic characteristic, and then of injecting into the network additional traffic corresponding to the first values of at least one of the chosen traffic characteristics, and of performing second active measurements on this additional traffic so as to determine whether it verifies at least one chosen condition.

The method according to the invention can include other characteristics which can be taken separately or in combination, and in particular:
one condition chosen from among one or more service level agreements, one or more characteristics defining a new service, and one or more reductions of quality,
it is possible to effect injection on demand in an automatic and periodic manner,
the first and second measurements are of the local type and/or of the type known as “end-to-end”,
it is possible to determine several traffic characteristics in order to deduce one or more traffic contents from these. For example, each traffic content is chosen from the source or the destination of the traffic, the class of service of the traffic, the protocol (of the network layer) used, and average volume of the data transmitted,
it is possible to determine one or more traffic profiles from the traffic content. For example, each profile is chosen from the temporal distribution of the traffic and the distribution of traffic payload,
it is possible to determine a quality of service from the traffic content and/or the traffic profile. The quality of service can be local, and determined from measurements such as the bandwidth employed, or indeed from end-to-end, and determined from measurements such as transmission delay, instability (jitter) or the rate of loss of data packets, and/or from statistical computering on these measurements,
it is possible to effect second active measurements on the additional traffic in order to determine the associated quality of service, and then to compare this quality of service with that of the chosen, previously determined traffic in order to deduce any variation from this. In this case, when the variation is greater than a selected threshold, it is advantageous to repeat the first passive measurements on the chosen traffic in order to determine new first values which are representative of each traffic characteristic chosen initially,
it is possible to inject auxiliary traffic into the network, corresponding to values which are representative of one or more auxiliary characteristics and equal to those first values to within a chosen deviation, and then to effect third active measurements on the auxiliary traffic, and finally to compare the third values of these third measurements with the second values obtained on the additional traffic, in order to determine an available quality of service margin in the light of the quality of service determined for the chosen traffic,
it is possible to inject auxiliary traffic into the network, where this traffic displays an auxiliary quality of service which is equal to that determined for the chosen traffic to within a chosen margin, and then to effect third active measurements on the auxiliary traffic, and to compare the third values of these third measurements with the second values obtained on the additional traffic, in order to determine the variations of traffic characteristics that are associated with the auxiliary quality of service.

The invention also concerns switching equipment within the communication network, consisting of elements of switching equipment coupled together to allow the establishment of traffic streams between communication terminals, and including
firstly, application means responsible for injecting additional traffic into the network corresponding to the first values received, representing at least one chosen traffic characteristic, and
secondly, measurement means capable of performing first passive measurements on at least one chosen traffic element, so as to deliver first values, and then of performing second active measurements on the additional traffic, so as to deliver second values which are representative of each chosen traffic characteristic, and
management means responsible for transmitting the first values of the chosen characteristics to the application resources, and for determining from the second values whether the additional traffic verifies at least one chosen condition.

The equipment according to the invention can include other characteristics which can be taken separately or in combination, and in particular:
management means responsible for choosing the condition, in accordance with instructions, from among one or more levels of service, one or more characteristics defining a new service, and one or more reductions of quality,
application means arranged so as to execute the injection following the reception of an instruction, or indeed automatically and in accordance with a selected periodicity,
measurement means arranged so as to effect first and second active local and/or end-to-end measurements,
measurement means arranged so as to deliver first values which are representative of several traffic characteristics, so that the management means are able to deduce one or more traffic contents from these first values, and then to store them in a memory,
management means arranged so as to determine one or more traffic profiles from one of the traffic contents, and then to store them in a memory,
management means arranged so as to determine one or more qualities of service (local or end-to-end) from at least one of the traffic contents and/or from at least one of the traffic profiles, and then to store them in a memory,
measurement means arranged so as to effect second active measurements on the additional traffic, in order that the management means can determine at least one quality of service associated with the results of these second active measurements, and then to compare the quality of service of the additional traffic with that of the chosen, previously determined, traffic in order to deduce any variation from this. For example, the management means can be arranged, when they detect a variation that is greater than a chosen threshold, so as to direct the measurement means to repeat the first passive measurements on the chosen traffic in order to determine the new values of the traffic characteristics chosen initially,
application means arranged so as to inject into the network, on receiving an instruction, auxiliary traffic which corresponds to values of one or more auxiliary characteristics equal to the first values previously determined to within a chosen deviation. In this case, the measurement means are preferably arranged to carry out third active measurements on the auxiliary traffic, and the management means are arranged so as to compare the values of these third active measurements with the second values obtained on the additional traffic, in order to determine an available quality of service margin in the light of the quality of service determined for the chosen traffic,
application means arranged so as to inject into the network, on receiving an instruction, auxiliary traffic meeting an auxiliary quality of service which is equal to that determined for the chosen traffic to within a chosen margin. In this case, the measurement means are preferably arranged to carry out third active measurements on the auxiliary traffic, and the management means are arranged so as to compare the results of these third active measurements with the second values obtained on the additional traffic, in order to determine which variations of traffic characteristics are associated with the auxiliary quality of service,
one or more management terminals equipped with management means and a memory. Each terminal can, for example, shape part of a network management system, or of a network management subsystem coupled to a network management system,
at least some of the switching equipment consists of edge routers or core routers.

Finally, it is an other object of the invention to provide a communication network which includes switching equipment coupled together so as to allow the establishment of traffic streams between communication terminals, characterised in that at least some of said switching equipment are in conformity with those described previously.

The invention is particularly well suited, though in a non-limiting way, to IP type (Internet Protocol) communication networks. In such a situation, the switching equipment is usually referred to as “routers”.

Other characteristics and advantages of the invention will appear on examining the following detailed description, and the appended drawing, on which the single FIGURE illustrates schematically, an example of implementation of a communication network according to the invention. The appended drawing can not only serve to complete the invention, but also contribute to its specification, as appropriate. The purpose of the invention is to enable management of the traffic within a communication network.

In what follows, we will consider that the communication network is an Internet protocol (IP) network. However the invention is not limited to this type of network only. It also concerns networks of the ADSL type in particular.

As illustrated in the single FIGURE, an internet network (N) can be considered to be schematically similar to a set of switching equipment (or nodes) (RPi and RC), connected together so as to provide for the routing of data packets that they receive, and to a set of communication terminals (Tj), connected to certain communication equipment (or nodes) (Rpi), via one or more other terminals of the access server type where appropriate, so as to exchange data packets with each other.

The switching equipment (or nodes) are generally edge routers (Rpi) (here i=1 to 4, but it can take any value equal to or greater than one), and core routers. Here, a single core router (RC) has been shown, but there can be others.

In what follows, as a non-limited example, it is considered that all the switching equipment (RPi and RC) employs at least the IPv4 version of the network layer protocol (or IPv6 as a variant).

Moreover, “communication terminal” (Tj) (here j=1 to 6, but it can take any value equal to or greater than two) refers here to all network equipment capable of exchanging data packets, such as, for example, a portable or fixed computer, a fixed or mobile telephone, a personal digital assistant (PDA), or a server.

In addition, it is considered in what follows that the network (N) includes a network management system (NMS) coupled, in particular, to its switching equipment (RPi and RC).

The network management system (NMS), also called the network operating system, in particular enables network supervisor (or manager) to manage the switching equipment (RPi and RC) of which it is composed. To this purpose, the switching equipment (RPi and RC) is arranged so as to be able to exchange data with the network management system (NMS), in accordance with a network management protocol such as, for example, the SNMP protocol (the RFC 2571-2580 simple network management protocol).

The purpose of the invention is to enable the management of certain traffic streams, such as user or customer traffic for example, within the network (N), and between selected terminals (Tj) which have service level agreements (SLA) with the operator of the network. As indicated previously, these SLAs contain parameter values or traffic characteristics which define, for each customer, a quality of service (QoS) with which the operator undertakes to provide it.

In order to allow monitoring of the quality of service of at least some of the user traffic within the network (N), at least some of the Routers (RPi and RC) are equipped with measurement modules (MM), preferably internally. Each measurement module (MM) is, at least functionally, subdivided into two parts, MM1 and MM2, intended respectively to effect passive and active measurements of the local or end-to-end type, on at least one user traffic stream passing through the router in which it is installed.

The purpose of these passive measurements is to enable the first parts (MM1) of the passive measurement modules (MM) to deliver values (or measurement results) representing selected characteristics (or parameters) of a given user traffic stream. These passive measurements specifically concern the given user traffic stream and are, for example, measurements of the traffic flow at the measurement point, counts of the number of packets in the traffic stream or of the number of bits of the traffic stream which have passed through the measurement point, or recordings of the observation date. These values are sent by transmit/receive module (MER) included in each router (Rpi or RC), via the links (or connections) of network (N), to a management module (MG) installed, for example, in a management server (or terminal) (S) of the NMS, as illustrated. As a variant, the server (S) could belong to a management subsystem that is responsible for managing the traffic in one part of the network (N), and preferably coupled to the (main) NMS of said network (N).

As will be seen later, these traffic characteristics or parameters will enable the management module (MG) to determine, in particular, one or more traffic contents, such as, for example, the source or the destination of the traffic, the class of service of the traffic, the network layer protocol employed, or the mean volume of the data transmitted.

In the illustrated example, all the edge routers (RPi) and core router (RC) are equipped with a measurement module (MM). But, it is possible to envisage that only the edge routers (RPi), or only some of them indeed, may be equipped with passive measurement modules (MM). The installation of a measurement module (MM) in an core router (RC) is particularly useful when a portion of the network needs to be capable of being tested, and in particular in the event of detection of a local drop in the quality of service.

When it has received the first values, the management module (MG) is responsible for determining the traffic characteristics represented by these, and then for storing these values in a memory (M), referenced to the associated traffic.

In addition, it is able to determine one or more traffic contents from these first values of traffic characteristics. This traffic content can be obtained by interpreting the header of the observed packet (the header of the IP packet, for example), the headers of the higher-level protocols (TCP, UDP), or the effective load. The traffic content can, for example, concern the source of the data packets making up the user traffic stream, or the destination of the user traffic stream, or indeed the class of service of the user traffic stream or the network layer protocol employed (IPv4 or IPv6, for example), or the average volume of the data transmitted by said traffic. Operationally, the effective load can be interpreted in order to specify additional characteristics of the traffic content. Each content can be stored in the memory (M). However, it can also be cumulated over a chosen period, before it is so stored.

The management module (MG) can also be arranged so as to determine one or more traffic profiles from one or more traffic contents. The historical record of the user traffic is stored regarding the profile characteristics that need to be retraced such as, for example, the observation dates of the packets, and the size of the packets or the protocols. The profile can, for example, concern the temporal distribution of the traffic, or the traffic payload distribution, or protocol sequencing profile. The profile thus determined is then preferably stored in the memory (M).

The management module (MG) can also be arranged so as to determine a quality of service (QoS) from the passive measurements effected by the agents (MM1) and associated with one or more traffic contents and/or one or more traffic profiles. In terms of the transfer rate between two points containing measurement modules (MM), the quality of service (QoS) can be obtained, for example, by subtracting the date of observation of a given packet of the user traffic at these two points. More generally, any type of quality of service can be determine, and in particular the local QoS, from measurements such as the bandwidth employed or the number of packets which have been observed, and the end-to-end QoS, from measurements such as the transmission time, the instability (jitter), the rate of loss of data packets, and the effective number of packets having transited (this list is not exhaustive). The local or end-to-end quality of service can also be determined from statistical calculations performed on the aforementioned measurements, such as averages, variances, minima or maxima, for example.

The quality of service thus determined is then preferably stored in the memory (M).

Once the management module (MG) is in possession of the characteristics of the traffic subject to monitoring, whatever its shape (content, profile or QoS), it can transmit at least some of their (first) values to selected application modules (MA) installed in routers (here only those of the edge type (RPI)), but it could also concern the core router (RC) through which the traffic concerned is passing.

More precisely, the management module (MG) transmits the values of chosen characteristics to the application module (MA) which is installed in the edge router (RPi) connected to the terminal (Tj) that is supplying it with data packets (and thus constitutes a source). For example, the management module (MG) feeds values to the edge router (RP2) which is connected to terminal T3 for which there exists an SLA associated with the traffic with terminal T1 (which constitutes a destination) connected to edge router RP4. On receipt of these values, the application module (MA) configures itself so as to generate additional traffic corresponding to said values of traffic characteristics, and then it transmits this to the transmit/receive module (MER) of its edge router (here RP2), so that it is injected into the network (N) to be routed to the edge router (here RP4), this being the “final” recipient of the traffic concerned, subjected to the passive measurements.

Such injection is able to take place on command, on receiving instructions from the NMS, for example, or indeed in an automatic manner, periodically for example.

The additional traffic is intended to reproduce the corresponding user traffic stream as closely as possible. This is the reason for which it is generated, so as to satisfy the greatest number possible of characteristics of the monitored traffic, and if possible, all of its characteristics subjected to the first measurements.

This additional traffic is therefore also the subject of (second) active measurements. To this end, use is also made of measurement modules (MM) installed in the routers (RPi and RC), and more precisely their second part (MM2) which is devoted to active measurements. The second parts (MM2) of the measurement modules (MM) are arranged to recognise the additional traffic streams which arrive at their router, and to carry out second active measurements, preferably identical to the first measurements effected on the user corresponding traffic stream, and then to deliver second values, representative of the chosen characteristics, destined for the management module (MG).

The active measurements are measurements performed on parameters of the additional traffic (and not on the user traffic), and where the partial and/or local results can, where appropriate, be incorporated into the additional traffic, in the form, for example, of information used to calculate the results of the measurements in a different and generally more direct manner than that used for the first passive measurements. In other words, parts MM1 and MM2 operate differently, but generally deliver comparable measurement results.

These second active measurements are preferably of the same type as the first (passive) measurements, that is local or end-to-end, in order to allow comparison.

The management module (MG) is responsible for determining whether the additional traffic verifies at least one chosen condition from the second measurements it is receiving from the routers.

Several conditions can be subjected to such verification. It is possible, for example, to verify that the additional traffic satisfies the level of service specified by the SLA dedicated to the corresponding user traffic stream. This allows the operator to checks whether it is meeting the quality of service agreed with a user.

As a variant, it is possible to check whether the additional traffic satisfies a new service. In other words, this enables one to check whether the characteristics of the services associated with the traffic of a user can support a new service.

As another variant, the reductions in the quality of service, associated with a user traffic stream, are quantified by analysing the second values (of the second measurements), introduced by one or more network problems, in relation with their (first) nominal values. This allows one to use the traffic characteristics associated with these second values, and which correspondent to a deterioration, to determine the origin of the deterioration using diagnostic tools such as Root Cause Analysis, installed in the NMS.

Verification of the condition can consist, for example, of comparing the first values resulting from the first measurements, performed on the user traffic stream concerned, with the second values resulting from the second measurements, performed on the corresponding additional traffic. But, it can also concern a confrontation between traffic contents, or traffic profiles, or indeed qualities of service, obtained from first and second values.

The management module (MG) can thus deduce, from a verification, any variation of content, profile or quality of service (QoS).

As an example, in the event of detection of a variation of quality of service (QoS), the management module (MG) can be arranged so as to compare this variation with a selected threshold, and to order to the measurement modules (MM) concerned to repeat first passive measurements on the user traffic stream, associated with the additional traffic subject to the variation. On receipt of the new first values, the management module (MG) can then compare these with the preceding first values stored in the memory (M), and determine whether the variation previously determined on the additional traffic is in fact the result of a problem that has arisen in the network (N), or whether it is the result of a difference of methoding of the additional traffic by the network (N) due to its pseudo-determinist character.

Moreover, the application modules (MA) can be configured so as to inject into the network (N), on the order of the NMS for example, auxiliary traffic which corresponds to one or more (auxiliary) characteristics of values equal to the first previously determined values, to within a chosen deviation. The purpose of such auxiliary traffic, which is of the same type as additional traffic, is, for example, to enable the management module (MG) to determine a quality of service margin (such as a new temporal distribution) available in the network (N), in the light of the quality of service corresponding to the user traffic stream concerned.

When the routers concerned receive this auxiliary traffic, the second part (MM2) of their measurement modules (MM) perform third active measurements on it, preferably identical to the second active measurements previously effected on the corresponding additional traffic and whose results are comparable to the results of the first measurements on the user traffic stream. The (third) values resulting from these third measurements are then transmitted by the routers concerned, and more precisely by their transmit/receive modules (MER), to the management module (MG) which can then compare them with the second values previously obtained on the additional traffic, and which were stored in the memory (M). It can thus check whether the user traffic stream supports the variations in the values of characteristics, and deduce from this comparison, or from several successive comparisons, the quality of service margin available for the user traffic stream concerned.

As a variant and/or as an addition, the application modules (MA) can be configured so as to inject into the network (N), on the orders of the NMS for example, auxiliary traffic corresponding to an (auxiliary) quality of service equal to that determined for the chosen traffic to within a chosen margin. For example, the quality of service margin concerns the maximum value of the transmission time or jitter. The purpose of such auxiliary traffic, which is also of the same type as additional traffic, is, for example, to enable the management module (MG) to determine which variations of traffic characteristics can be used to support the auxiliary quality of service (that is a quality of service equal to the nominal QoS to within a chosen margin).

When the routers concerned receive this auxiliary traffic, the second part (MM2) of their measurement modules (MM) carries out third active measurements on it, preferably identical to the second active measurements previously effected on the corresponding additional traffic, the results of which are comparable to the results of the first passive measurements on the user traffic stream. The (third) values resulting from these third measurements are then transmitted by the routers concerned, and more precisely by their transmit/receive modules (MER), to the management module (MG) which can then compare them to the second values previously obtained from the additional traffic, and which were stored in the memory (M). It can thus determine how it is possible to vary the values of the characteristics which define the user traffic stream so that the associated quality of service remains within the tested margin.

The application modules (MA) and the management module (MG) of the network according to the invention can be created in the shape of electronic circuits, computer software modules, or a combination of circuits and software.

The invention also proposes a traffic management method for a communication network.

In particular, this can be implemented using the communication network (N) presented above, and using the switching equipment (RPi and RC) and its management server (S) in particular. Since the main and optional functions and sub-functions provided by the steps of this method are more or less identical to those provided by the measurement modules (MM), application modules (MA) and management module (MG) of the network (N), then only those steps implementing the main functions of the method according to the invention will be summarised in what follows.

This method consists of performing first passive measurements on at least traffic which has been chosen so as to deliver first values which are representative of at least one chosen traffic characteristic, and then of injecting, into the network (N), additional traffic corresponding to the first values of at least one of the chosen traffic characteristics, and of performing second active measurements on this additional traffic so as to determine if it verifies at least one chosen condition.

The invention is not limited to the embodiments of the communication network, the switching equipment, the management server and the traffic management method described above only as an example, but also covers all variants that can be envisaged by the skilled in the art in the context of the following claims.

Thus, in the preceding text, the issue was one of measurement modules and application modules installed in routers. But these modules can be housed in a dedicated unit or on a dedicated card designed to be connected to a router.

Moreover, in the preceding text there is the issue of a management module and a memory installed in a management server (or terminal) of a network management system (NMS). But, the management module and the memory can also be installed in a management server (or terminal) of a management subsystem coupled to the network management system (NMS) and responsible for managing part of the network.

1. A traffic management method for a communication network (N) that includes switching equipment (RPi, RC), characterised in that it comprises i) performing first passive measurements on at least traffic which has been chosen so as to deliver first values which are representative of at least one chosen traffic characteristic, and ii) injecting into said network (N) additional traffic corresponding to the first values of at least one of said chosen traffic characteristics, and then of performing second active measurements on said additional traffic so as to determine whether it verifies at least one chosen condition.

2. A method according to claim 1, characterised in that said condition is chosen within a group that includes at least one service level agreement, at least one characteristic defining a new service, and at least one deterioration of quality.

3. A method according to claim 1, characterised in that said first and second measurements are of the local type and/or of the type known as “end-to-end”.

4. A method according to claim 1, characterized in that several traffic characteristics are determined so as to deduce from these at least one traffic content.

5. A method according to claim 4, characterised in that said traffic content is chosen from the source of the traffic, the destination of the traffic, the class of service to which the traffic belongs, the (network layer) protocol used, and the average volume of the data transmitted.

6. A method according to claim 4, characterised in that at least one traffic profile is determined from said traffic content.

7. A method according to claim 6, characterised in that said traffic profile is chosen from the temporal distribution of the traffic and the distribution of traffic payload.

8. A method according to claim 4, characterised in that a quality of service is determined from said traffic content and/or said traffic profile.

9. A method according to claim 8, characterised in that a local quality of service is determined.

10. A method according to claim 9, characterised in that said local quality of service is determined from measurements chosen from a group that includes at least the bandwidth employed and the number of packets which have been observed, and/or statistical calculations on said measurements.

11. A method according to claim 8, characterised in that an end-to-end quality of service is determined.

12. A method according to claim 11, characterised in that said end-to-end quality of service is determined from measurements chosen from a group that includes at least the transmission time, the instability (jitter) and the rate of loss of data packets, and/or statistical calculations on said measurements.

13. A method according to claim 8, characterised in that second active measurements are performed on said additional traffic so as to determine the associated quality of service, and then said quality of service of the additional traffic is compared to the quality of service of the chosen traffic, previously determined, so as to deduce any variation from the latter.

14. A method according to claim 13, characterised in that if said variation is greater than a selected threshold, said first passive measurements are repeated on said chosen traffic so as to determine new first values that are representative at least of said chosen traffic characteristic.

15. A method according to claim 8, characterised in that one injects into said network (N) auxiliary traffic meeting at least one auxiliary characteristic with a value equal to the first value of said traffic characteristic previously determined to within a chosen deviation, and then third active measurements are performed on said auxiliary traffic, and the third values of these third measurements are compared with the second values previously obtained on said additional traffic, so as to determine an available quality of service margin in the light of said quality of service determined for said chosen traffic.

16. A method according to claim 8, characterised in that one injects, into said network (N), auxiliary traffic meeting an auxiliary quality of service which is equal to that determined for said chosen traffic to within a selected margin, and then third active measurements are performed on said auxiliary traffic, and the third values of these third measurements are compared with the second values previously obtained on said additional traffic, so as to determine which variations of traffic characteristics is/are associated with said auxiliary quality of service.

17. Switching equipment (RPi) belonging to a communication network (N) consisting of switching equipment (RPi, RC) coupled together so as to allow the establishment of traffic between communication terminals ((Tj), characterised in that it includes i) application means (MA) arranged to inject, into said network (N), additional traffic corresponding to first values received, representing at least one chosen traffic characteristic, and ii) measurement means (MM) capable of performing first passive measurements on at least one chosen traffic element, so as to deliver said first values which are representative of at least each chosen traffic characteristic, and then of performing second active measurements on said additional traffic, so as to deliver second values which are representative of each chosen traffic characteristic, and in that it includes management means (MG) arranged to transmit to said application means (MA) said first values and to determine, from said second values, whether said additional traffic verifies at least one chosen condition.

18. Equipment according to claim 17, characterised in that said management means (MG) are arranged so as to choose said condition, in accordance with instructions, from a group that includes at least one service level agreement, at least one characteristic defining a new service, and at least one deterioration of quality.

19. Equipment according to claim 17, characterised in that said application means (MA) are arranged to execute said injection on receiving an instruction.

20. Equipment according to claim 17, characterised in that said application means (MA) are arranged so as to execute said injection automatically and in accordance with a selected periodicity.

21. Equipment according to claim 17, characterised in that said measurement means (MM) are arranged so as to carry out first passive measurements and second active measurements of the local type and/or of the type known as “end-to-end”.

22. Equipment according to claim 17, characterised in that said measurement means (MM) are arranged so as to determine first values which are representative of several traffic characteristics, and in that said management means (MG) are arranged so as to deduce at least one traffic content from said first values of traffic characteristics, so as to store it in a memory (M).

23. Equipment according to claim 22, characterised in that said traffic content is chosen from the source of the traffic, the destination of the traffic, the class of service to which the traffic belongs, the (network layer) protocol used, and average volume of the data transmitted.

24. Equipment according to claim 22, characterised in that said management means (MG) are arranged so as to determine at least one traffic profile from said traffic content, in order to store it in a memory (M).

25. Equipment according to claim 24, characterised in that said traffic profile is chosen from the temporal distribution of the traffic and the distribution of traffic payload.

26. Equipment according to claim 22, characterised in that said management means are arranged so as to determine a quality of service from said traffic content and/or from said traffic profile, so as to store it in a memory (M).

27. Equipment according to claim 26, characterised in that said management means (MG) are arranged so as to determine a local quality of service.

28. Equipment according to claim 27, characterised in that said local quality of service is determined from measurements chosen from a group that includes at least the bandwidth employed and the number of packets which have been observed, and/or statistical calculations on said measurements.

29. Equipment according to claim 26, characterised in that said management means (MG) are arranged so as to determine an end-to-end quality of service.

30. Equipment according to claim 29, characterised in that said end-to-end quality of service is determined from measurements chosen from a group that includes at least the transmission time, the instability (jitter) and the rate of loss of data packets, and/or statistical calculations on said measurements.

31. Equipment according to claim 26, characterised in that said measurement means (MM) are arranged so as to carry out second active measurements on said additional traffic, and in that said management means (MG) are arranged so as to determine a quality of service associated with the second values of said second active measurements, and then to compare said quality of service of the additional traffic to the quality of service of the chosen traffic, previously determined, so as to deduce any variation from the latter.

32. Equipment according to claim 31, characterised in that said management means (MG) are arranged, in the event of detection of a variation greater than a selected threshold, to order said measurement means (MM) to repeat said first passive measurements on said chosen traffic, so as to determine new first values of the chosen traffic characteristic(s).

33. Equipment according to claim 26, characterised in that said application means (MA) are arranged so as to inject into said network (N), on receiving an instruction, auxiliary traffic meeting at least one auxiliary characteristic with a value equal to that of said traffic characteristic previously determined to within a chosen deviation, in that said measurement means (MM) are arranged so as to carry out third active measurements on said auxiliary traffic, and in that said management means (MG) are arranged so as to compare the values of said third active measurements with the values of said second active measurements previously effected on said additional traffic, so as to determine an available quality of service margin in the light of said quality of service determined for said chosen traffic.

34. Equipment according to claim 26, characterised in that said application means (MA) are arranged so as to inject into said network (N), on receiving an instruction, auxiliary traffic meeting an auxiliary quality of service which is equal to that determined for said chosen traffic to within a selected margin, in that said measurement means (MM) are arranged so as to carry out third active measurements on said auxiliary traffic, and in that said management means (MG) are arranged so as to compare the values resulting from said third active measurements with the values of said second active measurements previously effected on said additional traffic, so as to determine which variation(s) of traffic characteristics is/are associated with said auxiliary quality of service.

35. A communication network (N), consisting of switching equipment (RPi, RC) coupled together so as to allow the establishment of traffic between communication terminals (Tj), characterised in that at least some of said switching equipment (RPi) complies with claim 17.

36. A network according to claim 35, characterised in that it includes at least one management terminal or server (S) equipped with said management means (MG) and said memory (M).

37. A network according to claim 35, characterised in that said management terminal or server (S) belongs to a network management system (NMS).

38. A network according to claim 35, characterised in that said management terminal or server (S) belongs to a network management subsystem couple to a network management system (NSM).

39. A network according to claim 35, characterised in that at least some of said switching equipment are edge routers (RPi).

40. A network according to claim 35, characterised in that at least some of said switching equipment consists of core routers (RC).

41. A communication network (N) according to claim 35, characterised in that it employs the Internet protocol.
